(19) United States
(12) Patent Application Publication
(10) Pub. No.: US 2015/0267755 A1
(43) Pub. Date: Sep. 24, 2015

(54) BEARING POWER GENERATING CONFIGURATION

(71) Applicant: AKTIEBOLAGET SKF, Goeteborg (SE)

(72) Inventors: Frank Bartl, Grenzach-Wyhlen (DE); Joseph Erskine, Falkirk (GB); Sebastian Ziegler, Schweinfurt (DE); Andreas Clemens Van Der Ham, Utrecht (NL)

(21) Appl. No.: 14/395,138

(22) PCT Filed: Apr. 9, 2013
(86) PCT No.: PCT/EP2013/057381

§ 371 Date: Oct. 17, 2014

(30) Foreign Application Priority Data
Apr. 24, 2012 (EP) EP2012/057434

(51) Int. Cl. F16C 41/00; H02K 7/18; F16C 33/72

(52) U.S. Cl. CPC F16C 41/004; F16C 33/72; H02K 7/183

(57) ABSTRACT

A power generating bearing assembly comprising a power generating subassembly integrated into a bearing. The power generating subassembly utilizes the relative motion between a bearing inner ring and a bearing outer ring of the bearing to generate electrical power. A sealing system is attached to one of the bearings. The power generating subassembly includes an electrical generator in operational engagement with a magnetically polarized material. The electrical generator is attached to the non-sealing carrying bearing. The magnetically polarized material can be attached directly to the sealing system or carried by a magnetically polarized material mount ring. The relative motion between the rings engages the electrical generator and the magnetically polarized material causing a generator core of the electrical generator to create an electrical current.

### CROSS REFERENCE TO RELATED APPLICATIONS

This is a National Stage application claiming the benefit of International Application Number PCT/EP2013/057381 filed on 09 Apr. 2013 (Sep. 4, 2013), which claims the benefit of International Application Number PCT/EP2012/057434 filed on 24 Apr. 2012 (24.04.2012), both of which are incorporated herein by reference in their entireties.

### TECHNICAL FIELD OF THE INVENTION

The present invention relates to an apparatus and method for generating power during motion of a bearing.

### BACKGROUND

A bearing can be defined as any of various machine elements that constrain the relative motion between two or more parts to only the desired type of motion. This is typically to allow and promote free rotation about a longitudinal axis and/or restrain any linear movement of a component in a normal direction respective to the bearing. Bearings may be classified broadly according to the motions they allow and according to their principle of operation, as well as by the directions of applied loads they can handle.

Bearings undergo significant use, which causes wear to the various bearing components. Over time, the wear on the bearing can result in mechanical failure. Mechanical failure can impact the rotational motion and/or the axial linear restraint. Failure to control either of these movements can cause catastrophic failure to the machinery relying upon the bearing.

Bearing reliability and predictive servicing can impact the operation and uptime of equipment. Bearings are used in many applications, including vehicles, wind turbines, automated machinery, and the like. Over time, the bearings wear. Bearing failure during operation can cause significant damage to the equipment and possibly the surrounding area. The bearing failure could even potentially cause injury or death to people should the right circumstances come occur.

Bearing monitoring systems require power for operation. Power is utilized for operating the condition monitoring sensors, providing power for any computing devices, and providing power for transferring any collected information to a centralized system. The power is provided through wiring to the devices.

Bearing reliability and predictive servicing can be improved by monitoring the bearing. A monitoring system would require power. What is desired is a power generating system associated with the bearing assembly.

### SUMMARY OF THE INVENTION

The present invention is directed towards an apparatus and respective method for generating electrical energy during the operation of equipment comprising a bearing.

In a first aspect of the present invention, a power generating bearing assembly, the power generating bearing assembly comprising:

a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein the bearing engaging outer surface is sized to rotationally engage with said outer ring bearing engaging inner surface,
a sealing system provided between the bearing outer ring and the bearing inner ring, wherein the sealing system is secured to a sealing attachment ring, wherein the sealing attachment ring is one of the outer ring and the inner ring and the remaining ring is a respective rotational ring,
wherein the inner ring is rotatationally assembled within the outer ring bearing engaging inner surface;

an electrical power generator including a generator core comprising an electrical coil wound about a magnetic core to generate electrical power, the electrical generator being attached to the respective rotational ring;

a magnetically polarized material carried by the sealing system; and

a generator positioning system that carries the electrical power generator and positions the electrical power generator proximate the magnetically polarized material,

wherein the relative motion between the bearing outer ring and the bearing inner ring passes the magnetically polarized material across the generator core causing the generator core to create an electrical current.

In a second aspect, the system further includes a processing device comprising a set of digital instructions for monitoring and analyzing digital data provided by a condition monitoring system integrated into the bearing assembly.

In another aspect, the generator positioning system further comprises a radial tolerance compensating system. The radial tolerance compensating system can include a radial biasing member assembled between a fixed mounting member and the electrical power generator, a generator core radial gliding material located between the mating surface of the electrical power generator and a ring end surface of the respective rotational ring.

In another aspect, the generator positioning system further comprises an axial tolerance compensating system. The axial tolerance compensating system provides a magnetically polarized material spanning across a distance of an axially oriented surface. The electrical power generator can include a friction-reducing interface enabling the electrical power generator to positionally adjust across the axially oriented surface in an axial direction. The friction-reducing interface can include a circumferential gliding material, one or more bearings, and the like.

In another aspect, the generator core can be assembled with a longitudinal axis being in a radial orientation and the magnetically polarized material is assembled in an annular ring extending axially from the sealing system.

In another aspect, the magnetically polarized material can be provided in a complete annular ring; in a single section covering a partial circularly shaped section; or in a series of sections which are spatially at equal radial distances from a bearing ring center.

In another aspect, the generator core can be assembled with a longitudinal axis being in an axial orientation and the magnetically polarized material is assembled in an orientation substantially parallel with the sealing system.

In another aspect, the electrical power generator can be carried by a radial registration control member, wherein the radial registration control member enables radial positioning of the electrical power generator. The electrical power generator can be radially positioned by engaging one or more generator radial guide features with one or more generator guide tracks, wherein the generator guide track is formed within the sealing system. The generator radial guide features engage with the generator guide track to align the electrical power generator with the magnetically polarized material. A biasing member can be integrated into the power generating subassembly, ensuring the generator core remains positioned proximate to the magnetically polarized material during operation.

One advantage of the present invention is the ability to generate a continued electrical current during motion of one of the rings of the bearing. The power can be utilized to operate bearing condition monitored equipment. The inclusion of an electrical power-generating device eliminates any need for a locally stored power (such as by a battery) or conveyed power from an external power source. By generating power at the location, the system can operate completely independent and un-tethered from any other device by providing sufficient power for wireless signal communications. While yet another advantage is that operation of the monitoring system can be limited to the time where the bearing is undergoing rotation. Power is only applied to the system when the generator is subjected to the relative motion between the bearing outer ring and the bearing inner ring.

Bearings can be utilized on equipment deployed in remote locations. The location could complicate any provisions for externally provided power for monitoring the condition of the bearing. The bearing(s) can be integrated into the equipment at a location that is difficult to access, particularly for wiring. Further, wires can accidentally interfere or become abraded by any rotational movements or other movements of components of the equipment.

Another advantage enables the registration between the electrical power generator and the magnetically polarized material to adapt to changes and wear of the bearing. The mechanical interface includes features to accommodate for radial and axial changes between the electrical power generator and the magnetically polarized material.

The use of a magnetic density operated generator core eliminates any wear and reliability issues associated with moving components. Any contacting surfaces can include bearings, friction reduced surfaces, and the like to minimize any impact resulting from relative motion between two moving components contacting one another.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents an exemplary schematic diagram of a bearing power generator and bearing condition monitoring system;

FIG. 2 presents an isometric top view of an exemplary power generating bearing assembly;

FIG. 3 presents a sectioned view of the exemplary power generating bearing assembly originally introduced in FIG. 2, the section taken along section line 3-3 of FIG. 2; and

FIG. 4 presents an isometric top view of a second exemplary power generating bearing assembly.

Like reference numerals refer to like parts throughout the several views of the drawings.

### DETAILED DESCRIPTION OF THE PRESENT INVENTION

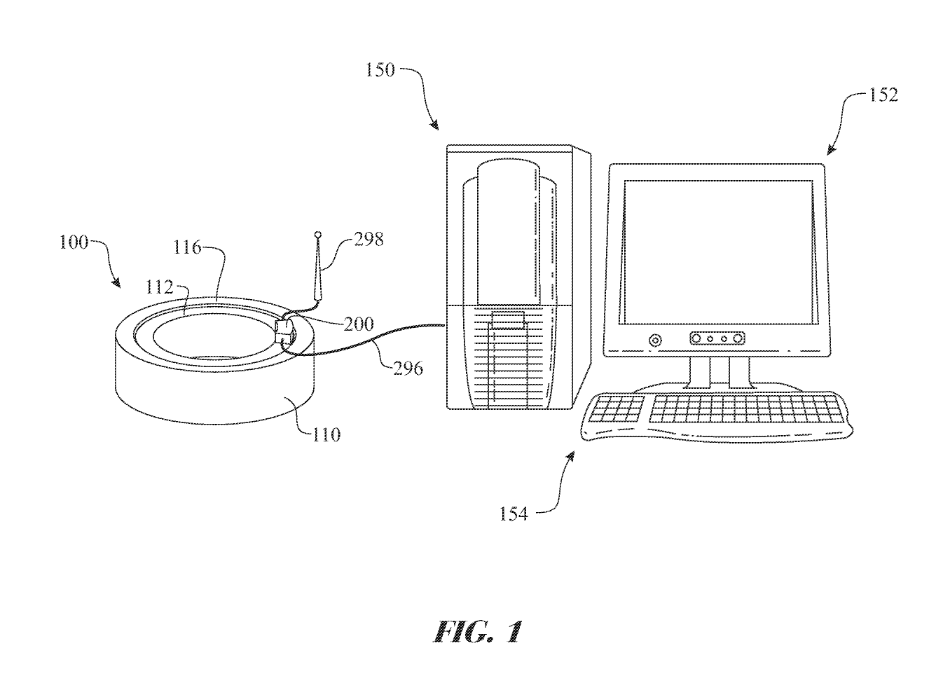

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A generic exemplary system schematic is presented in FIG. 1. The generic system includes a power generating bearing assembly 100 comprising a power generating subassembly 200 integrated into bearing 110. The bearing 110 is fabricated having a bearing inner ring 112 assembled within a bearing outer ring 116, wherein the interface between the bearing inner ring 112 and the bearing outer ring 116 restrains the relative motion to a rotational motion about a central axis. The relative rotational motion provided between the bearing inner ring 112 and the bearing outer ring 116 causes the power generating subassembly 200 to generate electrical energy in a form of an electrical current. The power generating subassembly 200 can include a sensor, a digital signal processor or any other device to embed a digital data signal within a current. The digital data signal is transmitted to a processing unit 150 via a wired signal interface 296 or preferably via a wireless signal interface 298. The wireless signal interface 298 includes circuitry and components respective to any selected wireless transmitting protocol. Power would be provided by the power generating subassembly 200 to operate the wireless signal interface 298.

The processing device 150 includes common digital data processing components, include a motherboard, at least one microprocessor, memory, a data recording device, digital instructions (such as software, firmware, and the like), input/output controllers, data communication devices, and the like. A user input device 154 and a user output device 152 are connected in signal communication to the processing device 150 through the input/output controllers. The digital data signal is received by the processing unit 150 and interpreted accordingly. The digital data signal would be provided when the power generating bearing assembly 100 is subjected to movement. The relative movement between the bearing inner ring 112 and the bearing outer ring 116 causes the power generating subassembly 200 to generate electrical power. Therefore, the electrical power is only available when the bearing inner ring 112 and bearing outer ring 116 are in relative motion to one another. It is understood that electrical power can be stored in a capacitor or battery integrated within the power generating subassembly 200. This would enable short cycles of additional power for continued operation after the bearing inner ring 112 and bearing outer ring 116 become stationary respective to one another. This would be beneficial for recording conditions of the bearing 110 after halting any operation, during cool down, and the like. The system can be recording conditions such as temperature, and the like.

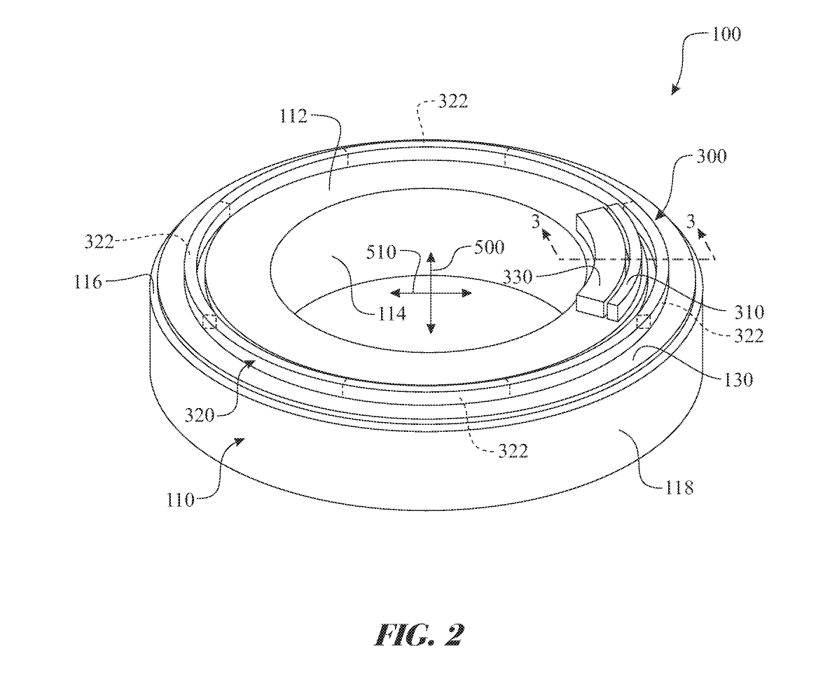

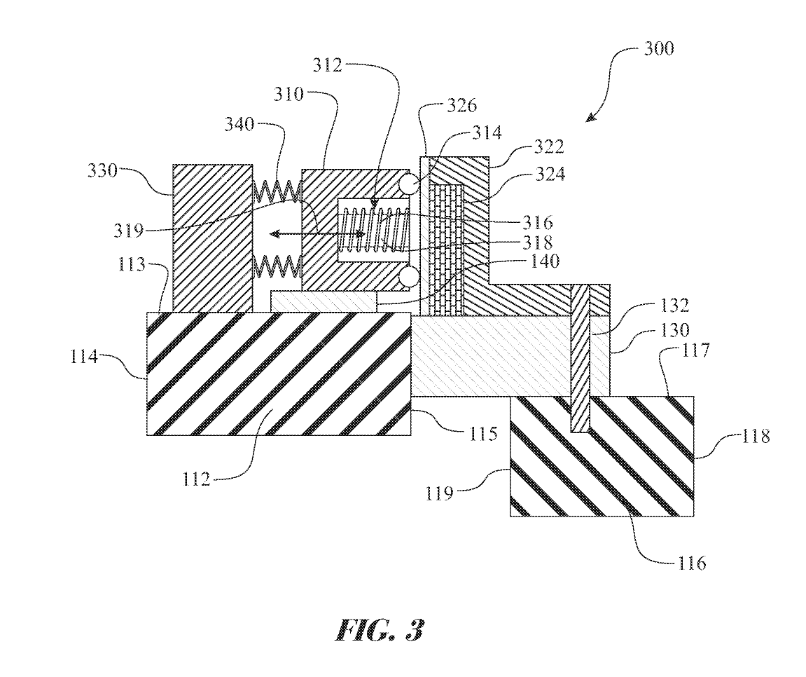

A first exemplary embodiment of the power generating subassembly 200 is presented as a power generating subassembly 300 illustrated in FIGS. 2 and 3. Orientation references are represented by the directional lines illustrated in FIG. 2. An axial direction 500 is parallel to the axis or rotation of the bearing rings 112, 116. A radial direction 510 is parallel to a radius of the bearing rings 112, 116. The illustrations present additional details of the bearing 110. Features of the bearing inner ring 112 can be referred to as: an bearing inner surface 114 defining an inner peripheral surface thereof; an bearing inner race engaging surface 115 defining an outer peripheral surface thereof; and an inner ring end surface 113 defining an end surface thereof. Features of the bearing outer ring 116 can be referred to as: a bearing outer surface 118 defining an outer peripheral surface thereof; a bearing outer race engaging surface 119 defining an inner peripheral surface thereof; and an outer ring end surface 117 defining an end surface thereof. At least one bearing race set (not shown) can be assembled between the bearing inner ring 112 and bearing outer ring 116. The bearing race set utilized can be any configuration known by those skilled in the art. A sealing system 130 can be attached to one of the bearing rings 112, 116. The bearing that retains the sealing system 130 can be referred to as a sealing attachment ring. The remaining ring is a respective rotational ring.

In the exemplary embodiment, the bearing 110 comprises a magnetically polarized material mount ring 320. The magnetically polarized material mount ring 320 can be provided as a complete annular ring extending axially from the sealing system 130. Alternatively, the magnetically polarized material mount ring 320 can be provided in a single section, referred to as a magnetically polarized material mount section 322 or multiple sections 322 equidistantly spaced about the bearing ring 112, 116, wherein each magnetically polarized material mount section 322 is located equidistant along a radial direction from a bearing center. The magnetically polarized material mount ring 320 (or magnetically polarized material mount section 322) includes a magnetically polarized material 324. The magnetically polarized material 324 can be any material or configuration of materials providing a variable reluctance. The magnetically polarized material 324 is assembled extending axially or perpendicular from the sealing system. The magnetically polarized material 324 can be secured to the sealing system 130 by a magnetically polarized material mount section 322. The magnetically polarized material mount section 322 is assembled to the sealing system 130 using any acceptable assembly interface. The exemplary assembly interface utilizes a mechanical assembly fastener 132. Alternative assembly interface options can include adhesive, providing the magnetically polarized material mount section 322 and sealing system 130 as a unitary construction, a mechanical interface such as a series of teeth and grooves, and the like, or any combination thereof. A circumferential gliding material 326 is preferably laminated over a contacting surface of the magnetically polarized material mount section 322/magnetically polarized material 324. The circumferential gliding material 326 provides a friction-reduced surface to reduce wear and aid in the reliability and longevity of the system. The magnetically polarized material mount ring 320/magnetically polarized material mount section 322 remains stationary upon the respective sealing attachment ring.

An electrical power generator 310 is assembled to an electronics box 330. The electronics box 330 is affixed to the respective rotational ring. The electrical power generator 310 is preferably biased against a circumferential gliding material 326 by at least one radial biasing member 340. Radial motion of the electrical power generator 310 can be aided by an inclusion of a generator core radial gliding material 140. The generator core radial gliding material 140 would be assembled between the electrical power generator 310 and the ring end surface 113, 117. The biasing force retains the electrical power generator 310 in contact with a mating surface of the circumferential gliding material 326. It is understood that the biasing force can be engineered to be overcome by air passing between the magnetically polarized material mount section 322 and the electrical power generator 310, wherein the air creates an air cushion therebetween. Alternatively, an optional plurality of circumferential motion bearings 314 can be integrated into either the electrical power generator 310 (as shown) or the magnetically polarized material mount section 322. The circumferential motion bearing 314 can be of any acceptable configuration known by those skilled in the art. It is understood that the circumferential gliding material 326 can be applied to a contacting surface of the electrical power generator 310 in an alternate embodiment or as an enhancement.

An electrical circuit can be integrated into the electronics box 330. The electrical circuit can include any monitoring circuitry and software; analysis circuitry and software; wired or wireless communication circuitry, hardware, and software, and the like.

In operation, as the bearing inner ring 112 and bearing outer ring 116 rotate respective to one another, the generator core 312 passes across the magnetically polarized material 324. The magnetically polarized material 324 includes variations in magnetic properties, wherein as the magnetically polarized material 324 moves relative to the generator core 312, the variations in magnetic properties changes the magnetic flux of a magnetic core 318 integrated into the generator core 312. The change in magnetic flux creates an electrical current in an electrical coil 316 wrapped about the magnetic core 318. The electrical current is conveyed to other equipment by wires or other electrical conduits.

It is understood that the magnetically polarized material mount section 322 can include a lead in taper to aid in engagement between the electrical power generator 310 and the magnetically polarized material mount section 322 as they pass by one another.

The radial biasing member 340 can be any compression spring, including a coil spring, a cantilevered spring, and the like.

The circumferential gliding material 326 can be any friction reducing material, including Polytetrafluoroethylene (PTFE), and the like. PTFE is a synthetic fluoropolymer of tetrafluoroethylene that finds numerous applications. The most well known brand name of PTFE is Teflon™ manufactured by the DuPont Company™. Other materials, including Polyoxymethylene (POM), also known as acetal, polyacetal, and polyformaldehyde, is an engineering thermoplastic used in precision parts that require high stiffness, low friction and excellent dimensional stability The most well known exemplary brand name of POM is Delrin™, also manufactured by the DuPont Company™.

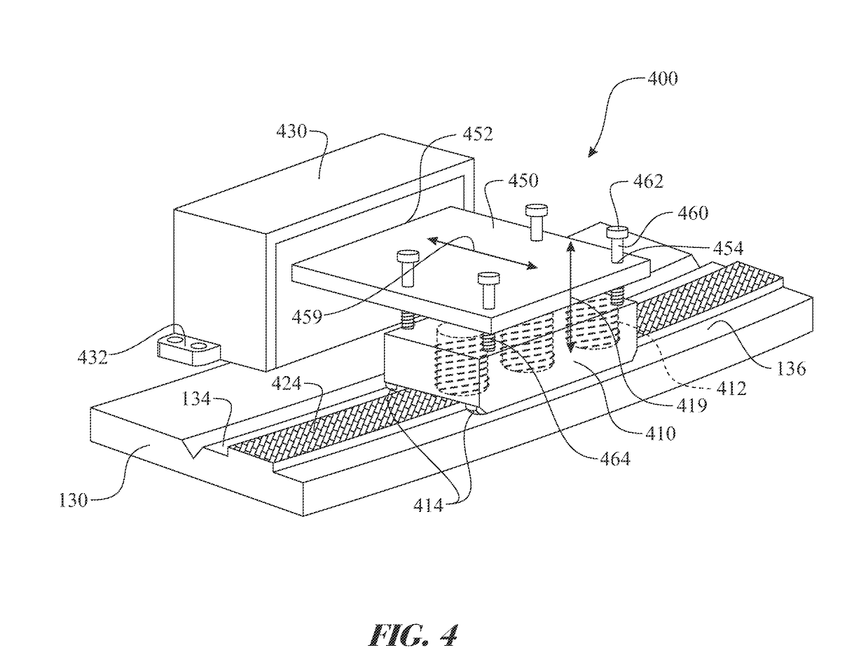

A second exemplary embodiment of the power generating subassembly 200 is presented as a power generating subassembly 400 illustrated in FIG. 4. The power generating subassembly 300 utilized a magnetically polarized material 324 oriented in a radial orientation extending axially from the bearing ring end surface. Contrarily, the power generating subassembly 400 utilizes a magnetically polarized material 424 oriented along a radial plane or a plane substantially parallel to a surface of the sealing system 130. The magnetically polarized material 424 is integrated into a section of the sealing system 130 in a format of an annular ring. It is understood that the magnetically polarized material 424 can be provided in a complete circumference of the annular ring, in a portion of the annular ring, or in a plurality of sections spatially arranged about the annular ring. The spatial arrangement is preferably equidistant. In the exemplary embodiment, the magnetically polarized material 424 is provided as a feature elevated above a surface of the sealing system 130. The raised magnetically polarized material 424 forms an inner generator guide track 134 on an interior side and an outer generator guide track 136 on an exterior side thereof.

An electrical power generator 410 is carried by a generator radial registration control member 450, where the generator radial registration control member 450 is supported by an electronics box 430. The electronics box 430 is secured to the respective rotational ring by any attachment interface. The electronics box 430 can include a generator box anchor 432 enabling attachment of the electronics box 430 to the respective rotational ring by a plurality of mechanical fasteners (not shown but well understood). The generator radial registration control member 450 is slideably assembled to the electronics box 430 through a registration control member sleeve 452. The registration control member sleeve 452 enables the generator radial registration control member 450 to move along a radial tolerance compensating motion 459. The electrical power generator 410 is assembled to the generator radial registration control member 450 by one or more axially positioning members. The exemplary embodiment employs a plurality of axial tolerance control members 460, enabling an axial tolerance compensating motion 419. The axial tolerance control member 460 are secured to the electrical power generator 410 and extend through apertures aperture 454, enabling axial movement of the axial tolerance control member 460. An axial tolerance control member cap 462 can be provided at an opposite end of the axial tolerance control member 460, wherein the axial tolerance control member cap 462 retains the axial tolerance control member 460 assembled to the generator radial registration control member 450. The electrical power generator 410 is retained against the sealing system 130 by a biasing force provided by an axial tolerance compensating biasing member 464. The axial tolerance compensating biasing member 464 extends between opposing faces of the electrical power generator 410 and the generator radial registration control member 450.

The inner generator guide track 134 and outer generator guide track 136 can be used as a guide for registration of an electrical power generator 410. A plurality of generator radial guide features 414 extends axially from a contacting surface of the electrical power generator 410. The generator radial guide feature 414 ride along each of the generator guide tracks 134, 136, ensuring the generator core 412 remains in alignment with the magnetically polarized material 424. The generator radial guide feature 414 can additionally ensure that predetermined gap remains between the generator core 412 and the magnetically polarized material 424. The radial guide features 414 and/or the generator guide tracks 134/136 are preferably made of any friction reduction material, including Polytetrafluoroethylene (PTFE), and the like. PTFE is a synthetic fluoropolymer of tetrafluoroethylene that finds numerous applications. The most well known brand name of PTFE is Teflon™ manufactured by the DuPont Company™. Other materials, including Polyoxymethylene (POM), also known as acetal, polyacetal, and polyformaldehyde, is an engineering thermoplastic used in precision parts that require high stiffness, low friction and excellent dimensional stability The most well known exemplary brand name of POM is Delrin™, also manufactured by the DuPont Company™.

The illustrated exemplary configuration assembles the electronics box 330, 430 to the bearing inner ring 112 and the sealing system 130 is affixed to the bearing outer ring 116. It is also understood that the electronics box 330, 430 can be assembled to the bearing outer ring 116 and the sealing system 130 is affixed to the bearing inner ring 112.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### REF. NO. DESCRIPTION

100 power generating bearing assembly
110 bearing
112 bearing inner ring
113 inner ring end surface
114 bearing inner surface
115 bearing inner race engaging surface
116 bearing outer ring
117 outer ring end surface
118 bearing outer surface
119 bearing outer race engaging surface
120 bearing race set
130 sealing system
132 mechanical assembly fastener
134 inner generator guide track
136 outer generator guide track
140 generator core radial gliding material
150 processing unit
152 output device
154 user input device
200 power generating subassembly
296 wired signal interface
298 wireless signal interface
300 power generating subassembly
310 electrical power generator
312 generator core
314 circumferential motion bearing
316 electrical coil
318 magnetic core
320 magnetically polarized material mount ring
322 magnetically polarized material mount section
324 magnetically polarized material
326 circumferential gliding material
330 electronics box
340 radial biasing member
400 power generating subassembly
410 electrical power generator
412 generator core
414 generator radial guide feature
419 axial tolerance compensating motion
424 magnetically polarized material
430 electronics box
432 generator box anchor
450 generator radial registration control member
452 registration control member sleeve
454 aperture
459 radial tolerance compensating motion
460 axial tolerance control member
462 axial tolerance control member cap
500 axial direction
510 radial direction

1. A power generating bearing assembly, the power generating bearing assembly comprising:
a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein said bearing engaging outer surface is sized to rotationally engage with said outer ring bearing engaging inner surface,
a sealing system provided between said bearing outer ring and said bearing inner ring, wherein said sealing system is secured to a sealing attachment ring, wherein said sealing attachment ring is one of said bearing outer ring and said bearing inner ring and said remaining ring is a respective rotational ring,
wherein said inner ring is rotationally assembled within said outer ring bearing engaging inner surface;
an electrical power generator including a generator core comprising an electrical coil wound about a magnetic core to generate electrical power, said electrical power generator being attached to said respective rotational ring;
a magnetically polarized material carried by said sealing system; and
a generator positioning system which carries said electrical power generator and positions said electrical power generator proximate said magnetically polarized material,
wherein a relative motion between said bearing outer ring and said bearing inner ring passes said magnetically polarized material across said generator core causing said generator core to create an electrical current.

2. A power generating bearing assembly as recited in claim 1, said generator positioning system further comprising at least one radial biasing member provided between an electronics box and said electrical power generator, said at least one radial biasing member applies a biasing force upon said electrical power generator urging said electrical power generator against towards magnetically polarized material.

3. A power generating bearing assembly as recited in claim 2, further comprising a circumferential gliding material positioned between said electrical power generator and said magnetically polarized material.

4. A power generating bearing assembly as recited in claim 3, further comprising a circumferential gliding material positioned between said electrical power generator and said inner ring end surface.

5. A power generating bearing assembly as recited in claim 2, further comprising a circumferential gliding material positioned between said electrical power generator and said inner ring end surface.

6. A power generating bearing assembly as recited in claim 2, further comprising a circumferential motion bearing positioned between said electrical power generator and said magnetically polarized material.

7. A power generating bearing assembly, the power generating bearing assembly comprising:
a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein said bearing engaging outer surface is sized to rotationally engage with said outer ring bearing engaging inner surface,
a sealing system provided between said bearing outer ring and said bearing inner ring, wherein said sealing system is secured to a sealing attachment ring, wherein said sealing attachment ring is one of said bearing outer ring and said bearing inner ring and said remaining ring is a respective rotational ring,
wherein said inner ring is rotationally assembled within said outer ring bearing engaging inner surface;
an electrical power generator including a generator core comprising an electrical coil wound about a magnetic core to generate electrical power, said electrical power generator being attached to said respective rotational ring;
a magnetically polarized material carried by said sealing system, said magnetically polarized material being oriented substantially parallel to an axial direction; and
a generator positioning system which carries said electrical power generator and positions said electrical power generator proximate said magnetically polarized material,
wherein a relative motion between said bearing outer ring and said bearing inner ring passes said magnetically polarized material across said generator core causing said generator core to create an electrical current.

8. A power generating bearing assembly as recited in claim 7, said generator positioning system further comprising at least one radial biasing member provided between an electronics box and said electrical power generator, said at least one radial biasing member applies a biasing force upon said electrical power generator urging said electrical power generator against towards magnetically polarized material.

9. A power generating bearing assembly as recited in claim 8, further comprising a circumferential gliding material positioned between said electrical power generator and said magnetically polarized material.

10. A power generating bearing assembly as recited in claim 9, further comprising a circumferential gliding material positioned between said electrical power generator and said inner ring end surface.

11. A power generating bearing assembly as recited in claim 8, further comprising a circumferential gliding material positioned between said electrical power generator and said inner ring end surface.

12. A power generating bearing assembly as recited in claim 8, further comprising a circumferential motion bearing positioned between said electrical power generator and said magnetically polarized material.

13. A power generating bearing assembly as recited in claim 7, wherein said magnetically polarized material is of a height enabling compensation for tolerances between said generator core and said magnetically polarized material along an axial direction.

14. A power generating bearing assembly, the power generating bearing assembly comprising:
a bearing comprising:
a bearing outer ring having an outer surface, a bearing engaging inner surface, and an outer ring end surface,
a bearing inner ring having a bearing assembly interior mating surface, a bearing outer race engaging surface, and an inner ring end surface, wherein said bearing engaging outer surface is sized to rotationally engage with said outer ring bearing engaging inner surface,
a sealing system provided between said bearing outer ring and said bearing inner ring, wherein said sealing system is secured to a sealing attachment ring, wherein said sealing attachment ring is one of said bearing outer ring and said bearing inner ring and said remaining ring is a respective rotational ring,
wherein said inner ring is rotationally assembled within said outer ring bearing engaging inner surface;
an electrical power generator including a generator core comprising an electrical coil wound about a magnetic core to generate electrical power, said electrical power generator being attached to said respective rotational ring;
a magnetically polarized material carried by said sealing system, said magnetically polarized material being oriented substantially parallel to a radial direction; and
a generator positioning system which carries said electrical power generator and positions said electrical power generator proximate said magnetically polarized material,
wherein a relative motion between said bearing outer ring and said bearing inner ring passes said magnetically polarized material across said generator core causing said generator core to create an electrical current.

15. A power generating bearing assembly as recited in claim 14, wherein said magnetically polarized material is carried upon an elevated surface formed in said sealing system, said elevated surface being defined by an inner generator guide track and an outer generator guide track; and
the electrical power generator further comprises at least two generator radial guide features, wherein said generator radial guide features are spaced having one generator radial guide feature located to ride upon said inner generator guide track and said other one generator radial guide feature located to ride upon said outer generator guide track.

16. A power generating bearing assembly as recited in claim 15, further comprising a generator radial registration control member extending from an electronics box and supporting said electrical power generator, wherein said generator radial registration control member enables positioning of said electrical power generator along a radial direction.

17. A power generating bearing assembly as recited in claim 16, further comprising an axial tolerance compensating element provided between said generator radial registration control member and said electrical power generator, wherein said axial tolerance compensating element urges said electrical power generator towards said magnetically polarized material.

18. A power generating bearing assembly as recited in claim 14, further comprising an axial tolerance compensating element, wherein said axial tolerance compensating element urges said electrical power generator towards said magnetically polarized material.
